(19) United States
(12) Patent Application Publication
(10) Pub. No.: US 2018/0205105 A1
(43) Pub. Date: Jul. 19, 2018

(54) ELECTROLYTE LAYER-ANODE COMPOSITE MEMBER FOR FUEL CELL AND METHOD FOR PRODUCING THE SAME

(71) Applicant: SUMITOMO ELECTRIC INDUSTRIES, LTD., Osaka-shi, Osaka (JP)

(72) Inventors: Hisao TAKEUCHI, Itami-shi, Hyogo (JP); Takashi MATSUURA, Itami-shi, Hyogo (JP); Naho MIZUHARA, Itami-shi, Hyogo (JP); Chihiro HIRAIWA, Itami-shi, Hyogo (JP); Tomoyuki AWAZU, Osaka-shi, Osaka (JP); Masatoshi MAJIMA, Itami-shi, Hyogo (JP)

(73) Assignee: SUMITOMO ELECTRIC INDUSTRIES, LTD., Osaka-shi, Osaka (JP)

(21) Appl. No.: 15/743,289

(22) PCT Filed: Jul. 8, 2016
(86) PCT No.: PCT/JP2016/070259

§ 371 Date: Jan. 10, 2018

(30) Foreign Application Priority Data
Jul. 17, 2015 (JP) 2015-143012

(51) Int. Cl. H01M 8/1253; H01M 8/126; H01M 4/86; H01M 4/88

(52) U.S. Cl. CPC H01M 8/1253; H01M 8/126; H01M 4/8668; H01M 2008/1293; H01M 2004/8689; H01M 2004/8684; H01M 4/8835

(57) ABSTRACT

An electrolyte layer-anode composite member for a fuel cell includes a solid electrolyte layer containing an ionically conductive metal oxide M1, a first anode layer containing an ionically conductive metal oxide M2 and nickel oxide, and a second anode layer interposed between the solid electrolyte layer and the first anode layer and containing an ionically conductive metal oxide M3 and nickel oxide. A volume content Cn1 of the nickel oxide in the first anode layer and a volume content Cn2 of the nickel oxide in the second anode layer satisfy the relation Cn1<Cn2.

### TECHNICAL FIELD

The present invention relates to an electrolyte layer-anode composite member including an ionically conductive solid electrolyte and a method for producing the electrolyte layer-anode composite member.

This application claims priority to Japanese Patent Application No. 2015-143012 filed Jul. 17, 2015, the entire contents of which are incorporated herein by reference.

### BACKGROUND ART

In a fuel cell including an ionically conductive solid electrolyte (SOFC), an anode includes a nickel (Ni) component serving as a catalyst and a solid electrolyte (metal oxide). Such an anode is typically formed by sintering a material containing a solid electrolyte and nickel oxide (NiO). A composite member (electrolyte layer-anode composite member) of a solid electrolyte layer and an anode is produced, for example, by forming an anode precursor by using a material containing a solid electrolyte and NiO, and then applying the solid electrolyte to the surface of the anode precursor, followed by co-sintering. Furthermore, performing a treatment to reduce NiO to Ni enhances the catalyst function of Ni and also makes the anode porous, allowing the anode to permeate fuel gas. In most cases, the reduction treatment is performed with the electrolyte layer-anode composite member incorporated into a fuel cell.

Specifically, when yttrium-doped barium cerate (BCY) is used as a solid electrolyte and NiO is used as Ni, an anode containing a powder mixture of BCY powder and NiO powder, which mixture is an anode material, is formed, and the BCY powder, which is a solid electrolyte layer material, is thinly applied to the anode. Co-sintering is then performed at a temperature at which both the materials become densified (typically about 1,300° C. to 1,500° C.) to obtain an electrolyte layer-anode composite member including a layer containing BCY and a layer containing BCY and NiO. The electrolyte layer-anode composite member is then incorporated into a fuel cell and subjected to a reduction treatment in an atmosphere of reducing gas such as hydrogen.

During the production process and the reduction process of the electrolyte layer-anode composite member, differences in expansion rate and contraction rate arise between the solid electrolyte layer and the anode. Therefore, the electrolyte layer-anode composite member may be warped during these processes. Warpage of the electrolyte layer-anode composite member may lead to degradation in power generation performance, and excessive warpage may result in breakage of the electrolyte layer-anode composite member.

PTL 1 discloses controlling the thermal expansion rate of a solid electrolyte. PTL 2 discloses controlling the dimensional change of a cell during the reduction of NiO.

### CITATION LIST

### Patent Literature

PTL 1: Japanese Unexamined Patent Application Publication No. 2013-206702

PTL 2: International Publication No. 2011/074445

### SUMMARY OF INVENTION

One aspect of the present invention relates to an electrolyte layer-anode composite member for a fuel cell. The electrolyte layer-anode composite member includes a solid electrolyte layer containing an ionically conductive metal oxide M1, a first anode layer containing an ionically conductive metal oxide M2 and nickel oxide, and a second anode layer interposed between the solid electrolyte layer and the first anode layer and containing an ionically conductive metal oxide M3 and nickel oxide. A volume content Cn1 of the nickel oxide in the first anode layer and a volume content Cn2 of the nickel oxide in the second anode layer satisfy the relation Cn1<Cn2.

Another aspect of the present invention relates to a method for producing an electrolyte layer-anode composite member for a fuel cell. The method includes a first step of preparing a solid electrolyte layer material containing an ionically conductive metal oxide M1, an anode material A containing an ionically conductive metal oxide M2 and a nickel compound N1, and an anode material B containing an ionically conductive metal oxide M3 and a nickel compound N2; a second step of forming a laminate of a precursor layer of a first anode layer containing the anode material A, a precursor layer of a second anode layer containing the anode material B, and a precursor layer of a solid electrolyte layer containing the solid electrolyte layer material, the precursor layers being deposited on one another in this order; and a third step of firing the laminate to form the first anode layer, the second anode layer, and the solid electrolyte layer. A volume content Cn1 of the nickel oxide in the first anode layer and a volume content Cn2 of the nickel oxide in the second anode layer satisfy the relation Cn1<Cn2.

Still another aspect of the present invention relates to a fuel cell including the electrolyte layer-anode composite member, a cathode, an oxidant channel for supplying an oxidant to the cathode, and a fuel channel for supplying a fuel to the anode.

### BRIEF DESCRIPTION OF DRAWINGS

FIG. 1A is a schematic sectional view of an electrolyte layer-anode composite member according to one embodiment of the present invention.

FIG. 1B is a schematic sectional view of an electrolyte layer-anode composite member according to another embodiment of the present invention.

FIG. 1C is a schematic sectional view of an electrolyte layer-anode composite member according to still another embodiment of the present invention.

FIG. 2 is a schematic sectional view of a fuel cell according to one embodiment of the present invention.

FIG. 3 is a schematic sectional view of a conventional electrolyte layer-anode composite member.

### DESCRIPTION OF EMBODIMENTS

### Problems to be Solved by the Present Disclosure

Warpage of an electrolyte layer-anode composite member (hereinafter referred to simply as a composite member) is caused by two factors: (i) a difference in thermal expansion rate during cooling after co-sintering between a solid electrolyte layer and an anode, and (ii) a difference in the amount of contraction during reduction treatment of NiO between the solid electrolyte layer and the anode. Therefore, methods in PTLs 1 and 2 are insufficient for suppressing warpage of an electrolyte layer-anode composite member.

### Effects of the Present Disclosure

According to the present invention, warpage of an electrolyte layer-anode composite member during the production process and the reduction process can be effectively suppressed without degrading the power generation performance of a fuel cell.

### DESCRIPTION OF EMBODIMENTS OF THE INVENTION

First, embodiments of the present invention will be enumerated and described.

(1) An electrolyte layer-anode composite member of the present invention includes a solid electrolyte layer containing an ionically conductive metal oxide M1, a first anode layer containing an ionically conductive metal oxide M2 and nickel oxide, and a second anode layer interposed between the solid electrolyte layer and the first anode layer and containing an ionically conductive metal oxide M3 and nickel oxide. A volume content Cn1 of the nickel oxide in the first anode layer and a volume content Cn2 of the nickel oxide in the second anode layer satisfy the relation Cn1<Cn2. This can suppress warpage during the production and the reduction treatment of the composite member while suppressing degradation in power generation performance of a fuel cell having the composite member incorporated therein.

(2) The Cn1 is preferably 40% to 80% by volume, and the Cn2 is preferably 50% to 90% by volume. This can further suppress warpage during the production process and the reduction process of the composite member while improving the power generation performance of a fuel cell having the composite member incorporated therein.

(3) When the solid electrolyte layer has a thickness Te of 3 to 50 μm, (T1+T2)/Te, which is a ratio of the total thickness of a thickness T1 of the first anode layer and a thickness T2 of the second anode layer to the thickness Te, is preferably 10 or more. This is because this improves the mechanical strength of the electrolyte layer-anode composite member while reducing resistance to ionic conduction in the solid electrolyte layer.

(4) The metal oxide M1, the metal oxide M2, and the metal oxide M3 preferably each have a perovskite crystal structure represented by ABO₃. This is because such a crystal structure provides high proton conductivity. In this case, A¹ site preferably contains at least one group 2 element, and B site preferably contains at least one of cerium and zirconium and a rare-earth element.

(5) In particular, the metal oxide M1, the metal oxide M2, and the metal oxide M3 are preferably each at least one selected from the group consisting of compounds represented by formula (1): BaCe₁₋ₐYₐO_{3-δ} (where 0<a≤0.5, and δ is an oxygen deficiency), formula (2): BaZr_{1-b}Y_{b}O_{3-δ} (where 0<b≤0.5, and δ is an oxygen deficiency), and formula (3): BaZr_{1-c-d}Ce_{c}Y_{d}O_{3-δ} (where 0<c<1, 0<d≤0.5, and δ is an oxygen deficiency). This is because these compounds provide even higher proton conductivity.

(6) The metal oxide M1, the metal oxide M2, and the metal oxide M3 may each contain zirconium dioxide (stabilized zirconia) doped with at least one selected from the group consisting of calcium, scandium, and yttrium. This is because these compounds have high oxygen ion conductivity and also tend to suppress degradation of the layers, which might otherwise be caused by phase transformation.

(7) The nickel oxide contained in at least one of the anode layers may be at least partially reduced to metal nickel.

This allows the electrolyte-anode composite member to exhibit its function when incorporated into a fuel cell.

(8) A method for producing an electrolyte layer-anode composite member for a fuel cell of the present invention includes a first step of preparing a solid electrolyte layer material containing an ionically conductive metal oxide M1, an anode material A containing an ionically conductive metal oxide M2 and a nickel compound N1, and an anode material B containing an ionically conductive metal oxide M3 and a nickel compound N2; a second step of forming a laminate of a precursor layer of a first anode layer containing the anode material A, a precursor layer of a second anode layer containing the anode material B, and a precursor layer of a solid electrolyte layer containing the solid electrolyte layer material, the precursor layers being deposited on one another in this order; and a third step of firing the laminate to form the first anode layer, the second anode layer, and the solid electrolyte layer.

A volume content Cn1 of the nickel oxide in the first anode layer and a volume content Cn2 of the nickel oxide in the second anode layer satisfy the relation Cn1<Cn2. According to this method, an electrolyte layer-anode composite member that undergoes little or no warpage can be efficiently produced.

(9) The production method preferably further includes a fourth step of at least partially reducing the nickel oxides contained in the first anode layer and the second anode layer. This is because the reduction enhances the catalyst function of Ni. The reduction also makes the anode layers porous, allowing the anode layers to permeate fuel gas.

(10) A fuel cell of the present invention includes the above-described electrolyte layer-anode composite member, a cathode, an oxidant channel for supplying an oxidant to the cathode, and a fuel channel for supplying a fuel to the anode. The fuel cell has high power generation performance and high durability.

### DETAILS OF EMBODIMENTS OF THE INVENTION

Embodiments of the present invention will now be described in detail. It should be noted that the present invention is not limited to the following description and is defined by the appended claims. All changes which come within the meaning and range of equivalency of the claims are to be embraced within their scope.

The linear expansion coefficient of nickel oxide (NiO), a catalyst precursor, is typically higher than that of a solid electrolyte (e.g., a metal oxide such as BCY or yttria-stabilized zirconia (YSZ)) used in a SOFC. The linear expansion coefficient of NiO is about 14×10⁻⁶/K, and the linear expansion coefficient of the metal oxide is about 8 to 12×10⁻⁶/K. Therefore, the thermal expansion rate of an anode containing these substances is typically higher than that of a solid electrolyte layer containing only a solid electrolyte that is the same as or different from the above solid electrolytes. Due to the difference in thermal expansion rate between the anode and the solid electrolyte layer (factor (i)) during the production process (mainly, during cooling after co-sintering) of a composite member, warpage occurs with the anode facing inward.

Common methods of suppressing the warpage due to factor (i) include using a thin solid electrolyte layer to increase the thickness ratio of solid electrolyte layer to anode, using a thick anode to increase the thickness ratio of anode to electrolyte layer and to increase anode rigidity, and decreasing the difference in thermal expansion rate between the solid electrolyte layer and the anode. However, there is a limit as to how thin the solid electrolyte layer can be, and a thick anode layer leads to an increase in fuel gas transfer resistance and also leads to increases in volume and mass.

An effective method for decreasing the difference in thermal expansion rate is decreasing the mixing ratio of the catalyst precursor in the anode. This is because the linear expansion coefficient of a composite material containing two or more different materials has a substantially linear relationship with a mixing ratio that takes into account the linear expansion coefficient and the elastic coefficient of each material. Therefore, decreasing the mixing ratio of the catalyst precursor (NiO), which has a higher linear expansion coefficient, can decrease the linear expansion coefficient of the anode, leading to a small difference in thermal expansion rate between the solid electrolyte layer and the anode.

However, decreasing the ratio of NiO in the anode inevitably decreases the Ni ratio in the anode after reduction. This results in lower electrical conductivity of the anode and a greater energy loss in drawing electric energy. Furthermore, the small amount of Ni at a boundary between the anode and the solid electrolyte layer, Ni being a catalyst for decomposing molecular hydrogen, decreases the capability of decomposing fuel gas (e.g., H₂) into protons (H⁺), leading to lower power generation performance.

The anode requires permeability to fuel gas. Fuel gas passes through pores that are formed in the anode as a result of reduction from NiO to Ni. Therefore, a small NiO ratio in the anode results in a low porosity of the anode after reduction treatment. Furthermore, pores are less likely to combine with each other, leading to increased fuel gas diffusion resistance in the anode, and hence lower power generation performance. Fuel gas may be passed not through the pores formed in the above manner but through pores introduced using a foaming agent or the like during the formation of the anode. In this method, however, a conducting agent or the like needs to be added in order to impart electrical conductivity to the anode, which makes the production process complex. Moreover, since the pores change their shape in a firing step, it is difficult to control the contraction rate of the anode.

Factor (ii) in the occurrence of a difference in the amount of contraction during the reduction process between the solid electrolyte layer and the anode is a volume decrease of the anode mainly due to the reduction from NiO to Ni. The solid electrolyte layer, which contains no NiO, does not exhibit any significant volume change. Therefore, warpage of the composite member during the reduction process occurs in the same direction as the direction in which the warpage due to the difference in linear expansion coefficient occurs during the production process. In addition, hydrogen dissolution into the solid electrolyte or compressive stress release may expand the solid electrolyte layer. In this case, the difference in the amount of contraction between the solid electrolyte layer and the anode further increases. This warpage can be suppressed by suppressing the volume decrease of the anode.

Taken together, decreasing the NiO content of the anode can eliminate factors (i) and (ii) in warpage. However, decreasing the NiO content of the anode results in lower power generation performance, as described above. That is, there is a trade-off between overcoming of warpage and power generation performance.

The volume decrease of the anode and the NiO content of the anode are not in a linear proportional relationship. This is different from the fact that the linear expansion coefficient of a composite material has a substantially linear relationship with a mixing ratio that takes into account the linear expansion coefficient and the elastic coefficient of each material.

Firing causes metal oxide powder and NiO powder to each strongly compact (sinter).

That is, as a result of sintering of the powders, backbones containing either powder are formed in the anode. When the NiO content is small, the amount of contraction of the backbone containing NiO is small after reduction treatment, and the backbone containing a relatively large amount of metal oxide powder is firmly formed. Therefore, the shape of the backbone containing the metal oxide tends to be maintained. That is, the reduction from NiO to Ni forms pores but causes little or no decrease in the apparent volume of the anode.

By contrast, when the NiO content exceeds a threshold, the backbone containing the metal oxide is not sufficiently formed, and the backbone containing NiO shows a significant contraction as a result of reduction treatment. The contraction of the backbone containing NiO makes it difficult to maintain the shape of the backbone containing the metal oxide. This results in a contraction of the external shape of the anode and a great decrease in apparent volume. When the NiO content exceeds a range over which it is difficult to maintain the backbone after reduction, the volume decrease of the anode rapidly increases. The rigidity of the backbone is also affected by the type, particle size, etc. of the powder used. That is, the volume decrease of the anode and the NiO content of the anode are not in a linear proportional relationship; thus, it is very difficult to determine a NiO content that can achieve both overcoming of warpage and power generation performance.

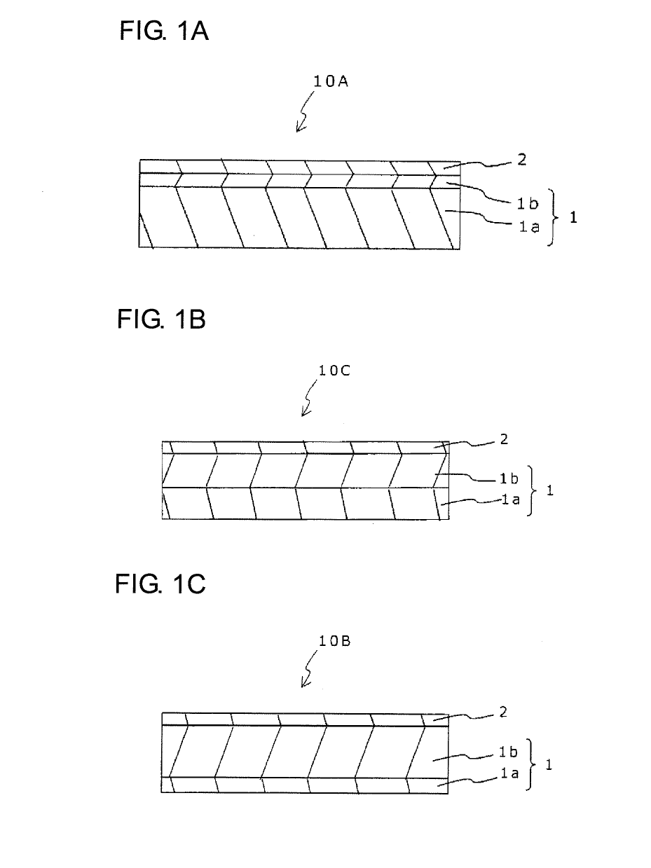

Intensive studies have revealed that, as shown in FIGS. 1A to 1C, a configuration in which an anode 1 is composed of multiple anode layers (a first anode layer 1a and a second anode layer 1b) having different NiO contents can achieve both overcoming of warpage and power generation performance. In other words, the combined use of multiple anode layers whose NiO contents, i.e., linear expansion coefficients are different for the anode 1 can achieve both overcoming of warpage and high power generation performance.

For the NiO content of the anode layers, the NiO content of the second anode layer 1b, which is interposed between a solid electrolyte layer 2 and the first anode layer 1a, is highest. Therefore, a linear expansion coefficient αa of the first anode layer 1a and a linear expansion coefficient αb of the second anode layer 1b satisfy the relation αa<αb. A linear expansion coefficient αe of the solid electrolyte layer, αa, and αb satisfy the relation αe<αa<αb.

That is, the second anode layer 1b, which has a higher linear expansion coefficient, is intentionally interposed between the solid electrolyte layer 2 and the first anode layer 1a. The second anode layer 1b may have any thickness. For example, when a thickness T2 of the second anode layer 1b is smaller than a thickness T1 of the first anode layer 1a (case 1: for example, the thickness T2 is at least one order of magnitude (at least 10 times) smaller than the thickness T1), the solid electrolyte layer 2, which has a lower linear expansion coefficient, and the second anode layer 1b, which has a higher linear expansion coefficient, can be regarded as a single composite layer. Controlling the linear expansion coefficient of the composite layer allows thermal contraction rates of the composite layer and the first anode layer 1a during cooling after co-sintering and during cooling after reduction treatment to be at the same level. Thus, a composite member that undergoes little or no warpage is provided. In addition, in this case, since the proportion of the first anode layer 1a, which has a lowest NiO content, in the composite member is relatively large, the contraction rate in a direction of a principal surface of the entire composite member advantageously tends to be small.

For example, in the case of a composite member including a solid electrolyte layer containing BCY and having a thickness of 10 μm, the second anode layer 1b containing BCY (30% by volume) and NiO (70% by volume) and having a thickness of 20 and the first anode layer 1a containing BCY (50% by volume) and NiO (50% by volume) and having a thickness of 0.5 mm, an approximate linear expansion coefficient (a value obtained taking into account the contents of the metal oxides, hereinafter the same) αe of the solid electrolyte layer, an approximate linear expansion coefficient αb of the second anode layer 1b, and an approximate linear expansion coefficient αa of the first anode layer 1a are calculated. In calculating the approximate linear expansion coefficients, the linear expansion coefficients of the materials (BCY and NiO) are assumed to be as follows: BCY, 11×10⁻⁶/K; NiO, 14×10⁻⁶/K. The approximate linear expansion coefficients of the layers are calculated to be as follows: αe=11×10⁻⁶/K, αb=0.7×14×10⁻⁶/K+0.3×11×10⁻⁶/K=13.1×10⁻⁶/K, αa=0.5×14×10⁻⁶/K+0.5×11×10⁻⁶/K=12.5×10⁻⁶/K.

Assuming that the solid electrolyte layer 2 and the second anode layer 1b is regarded as a single layer and the composite layer (thickness: 30 μm) of the solid electrolyte layer 2 and the second anode layer 1b is deposited on the first anode layer 1a, an approximate linear expansion coefficient αbe of the composite layer is about 12.4×10⁻⁶/K (=11×10⁻⁶/K×(⅓)+13.1×10⁻⁶/K×(⅔)), which differs from the linear expansion coefficient (αa=12.5×10⁻⁶/K) of the first anode layer 1a by as little as 0.1×10⁻⁶/K. This difference is very small as compared to a linear expansion coefficient difference Δα(=αa−αe=12.5×10⁻⁶/K−11.0×10⁻⁶/K)=1.5×10⁻⁶/K in the case where the solid electrolyte layer 2 is directly deposited on the first anode layer 1a. In this case, even given that the thickness (30 μm) of the composite layer deposited on the first anode layer 1a is three times the thickness (10 μm) of the solid electrolyte layer 2 alone, warpage due to a difference in linear expansion coefficient (factor (i)) is significantly suppressed.

The thickness T2 of the second anode layer 1b may be about the same as the thickness T1 of the first anode layer 1a (case 2: for example, the thickness T2 is more than 1/10 and less than 10 times the thickness T1). An example of case 2 is a case where the first and second anode layers each have a thickness of 0.5 mm and the solid electrolyte layer 2 having a thickness of 10 μm is formed on a surface of the second anode layer 1b.

First, in the case of a laminate (anode laminate) of the first and second anode layers alone, the anode laminate undergoes warpage with the second anode layer 1b facing inward. This is because the linear expansion coefficient of the second anode layer 1b is larger than the linear expansion coefficient of the first anode layer 1a. However, disposing the solid electrolyte layer 2, which has a lower linear expansion coefficient, on a surface of the anode laminate on the second anode layer 1b side cancels a moment M (see below) of the entire composite material to suppress warpage. This is because the difference in thermal contraction rate between the solid electrolyte layer 2 and the second anode layer 1b is larger than the difference in thermal contraction rate between the second anode layer 1b and the first anode layer 1a.

In case 2, the difference in NiO content (linear expansion coefficient) between the two anode layers may be small. Also in this case, the amount of warpage of the anode laminate is large, and therefore disposing the solid electrolyte layer 2 on the second anode layer 1b side is highly effective. Case 2, in which the difference in NiO content between the two anode layers can be small, is advantageous in that the integrity of a bonding boundary between the two anode layers can be increased. High integrity means, for example, that a local stress at the boundary is low.

When the thickness T2 is larger than the thickness T1 (case 3: for example, the thickness T2 is at least one order of magnitude (at least 10 times) larger than the thickness T1), disposing the first anode layer 1a, which has a lower linear expansion coefficient than the second anode layer 1b, on a surface of the second anode layer 1b not facing the solid electrolyte layer 2 can provide a composite member that undergoes little or no warpage. This is because by disposing the layers each having a lower linear expansion coefficient on both sides of the second anode layer 1b having a larger thickness, a moment M of the entire composite material is canceled. In case 3, the second anode layer 1b is subjected to compressive stress on both sides. This advantageously inhibits the progress of cracking starting from the surfaces of the second anode layer 1b prone to defects, thus suppressing breakage of the composite material itself.

As described above, the contraction of the anode 1 (factor (ii)) which accompanies a volume decrease during reduction treatment tends to abruptly increase when the NiO content exceeds a threshold (typically 50% to 70% by volume). Therefore, unlike factor (i), it is difficult to discuss using the calculation of an approximate volume change (volume decrease, in this case). However, there is a tendency that the difference in the amount of contraction between the solid electrolyte layer 2 and the anode 1 after reduction treatment increases as the NiO content of the anode 1 increases. Therefore, satisfying the relation Cn1<Cn2, where Cn1 is a NiO content of the first anode layer 1a and Cn2 is a NiO content of the second anode layer 1b, is effective in suppressing warpage due to reduction treatment. A NiO content that can achieve both overcoming of warpage and power generation performance can be calculated by experimentally determining the relationship between the NiO content and the amount of contraction during reduction.

In addition, since the second anode layer 1b, which has a higher NiO content, faces the solid electrolyte layer 2, H₂ (fuel gas) that has passed through the first anode layer 1a is efficiently decomposed into protons by catalysis of Ni at a boundary between the solid electrolyte layer 2 and the second anode layer 1b. This provides improved power generation performance. That is, the above-described configuration of the anode 1 can achieve both overcoming of warpage and power generation performance.

The NiO content Cn1 of the first anode layer 1a is not limited to any particular value, but in view of the balance between suppression of warpage and power generation efficiency, Cn1 is preferably 40% to 80% by volume, more preferably 45% to 70% by volume. The NiO content Cn2 of the second anode layer 1b is not limited to any particular value as long as it is higher than Cn1. In particular, from the same viewpoint as Cn1, the content Cn2 is preferably 50% to 90% by volume, more preferably 55% to 80% by volume. A NiO content Cn of the entire anode is, for example, about 40% to 80% by volume.

The contents Cn1 and Cn2 can be determined taking into account the amount of contraction of the entire anode layer. That is, the contents Cn1 and Cn2 may vary depending on the thicknesses of the first anode layer 1a and the second anode layer 1b. A thickness Te of the solid electrolyte layer 2 is not limited to any particular value.

In the reduction treatment, Ni atoms hardly scatter out of the system under the conditions in reducing NiO to Ni. Therefore, if the NiO contents Cn1 and Cn2 satisfy Cn1<Cn2, Cn1r, which is a content of Ni (or the total of NiO and Ni) in the first anode layer 1a after reduction treatment, and Cn2r, which is a content of Ni (or the total of NiO and Ni) in the second anode layer 1b after reduction treatment, also satisfy Cn1r<Cn2r. In other words, if the composite member after reduction treatment satisfies Cn1r<Cn2r, the composite member before reduction satisfies Cn1<Cn2.

The volume content of NiO or Ni in the anode 1 can be calculated using an SEM photograph of a section of the anode 1. Specifically, first, in an SEM photograph of a section of the anode 1, a region R containing 100 or more NiO or Ni particles is determined. The region R contains metal oxide particles, NiO or Ni particles, and pores. When the depth (the length in the normal direction of the SEM photograph) of the region R is assumed to be sufficiently smaller than the diameter of NiO or Ni particles, the volume content of NiO or Ni can be determined by dividing the total region of all the NiO or Ni particles by the area of the region R. The volume content of NiO or Ni may be determined by calculating the volume content of NiO or Ni in two or more (e.g., five) regions R of the same anode 1 as described above and averaging the obtained values. Alternatively, the volume content of NiO or Ni can be calculated by inductively coupled plasma-atomic emission spectroscopy (ICP-AES). In this case, a powder obtained by scraping the first anode layer 1a or the second anode layer 1b is decomposed, for example, by acid decomposition or melted, and the resultant is used as a sample.

The effect of the configuration in which the anode 1 is composed of at least two anode layers on suppression of warpage can be determined as a rate of change in the amount of warpage (hereinafter referred to as warpage change index i) due to a difference in linear expansion coefficient. The reason why warpage is caused by factor (i) is as follows: when the thickness direction of the composite material is taken as Z axis, and a central point C of a thickness T of the entire composite material is taken as a coordinate (Zc), a moment M around the central point C changes. Thus, the rate of change in moment M is used as the warpage change index i.

The moment M can be considered to be a sum of moments of layers calculated taking into account the difference between a linear expansion coefficient of a base layer and linear expansion coefficients of other layers. The warpage change index i can be calculated by dividing the moment M by a moment M₀ of a composite member 100 (see FIG. 3) including an anode 1 composed of a single monolithic anode layer (which is referred to as a first anode layer 1a) alone.

In the case of the composite member 100, the first anode layer 1a is a base layer. A moment generated by a solid electrolyte layer 2 is expressed as K(Ze−Zc)(αe−αa)), and a moment generated by the first anode layer 1a is expressed as K(Za−Zc)(αa−αa). Since the moment generated by the first anode layer 1a is 0 (zero), the moment M₀ is expressed as K(Ze−Zc)(αe−αa). In the expressions, K represents a constant determined, for example, from the thickness T of the composite material, Za represents a coordinate of the central point of the thickness T1 of the first anode layer 1a, Ze represents a coordinate of the central point of the thickness Te of the solid electrolyte layer 2, αe represents a linear expansion coefficient of the solid electrolyte layer 2, and αa represents a linear expansion coefficient of the first anode layer 1a.

### (1) Case 1

In case 1 (see FIG. 1A), the first anode layer 1a, having a sufficient thickness, is a base layer. That is, moments of the layers are expressed as follows:

Me=K(Ze−Zc)(αe−αa)

Ma=K(Za−Zc)(αa−αa)=0

Mb=K(Zb−Zc)(αb−αa).

In the expressions, Zb represents a coordinate of the central point of the thickness T2 of the second anode layer 1b, and αb represents a linear expansion coefficient of the second anode layer 1b.

Thus, the moment M equals (Me+Mb), and the warpage change index i is expressed as (Me+Mb)/M₀. Presumably, when the warpage change index is positive, warpage occurs such that the solid electrolyte layer 2 side is convex, and when the warpage change index is negative, warpage occurs such that the solid electrolyte layer 2 side is concave.

### (2) Case 2

In case 2 (see FIG. 1B), both the first anode layer 1a and the second anode layer 1b are base layers. Therefore, a weighted average coefficient of thermal expansion (=αav) determined taking into account the thicknesses of the first anode layer and the second anode layer is used as a linear expansion coefficient of the base layers. In this case, moments of the layers are expressed as follows:

Me=K(Ze−Zc)(αe−αav)

Ma=K(Za−Zc)(αa−αav)

Mb=K(Zb−Zc)(αb−αav).

Thus, the moment M equals (Me+Ma+Mb), and the warpage change index i is expressed as (Me+Ma+Mb)/M₀.

### (3) Case 3

In case 3 (see FIG. 1C), the second anode layer 1b, having a sufficient thickness, is a base layer. That is, moments of the layers are expressed as follows:

Me=K(Ze−Zc)(αe−αb)

Ma=K(Za−Zc)(αa−αb)

Mb=K(Zb−Zc)(αb−αb)=0.

Thus, the moment M equals (Me+Ma), and the warpage change index i is expressed as (Me+Ma)/M₀.

Presumably, the linear expansion coefficients of the layers substantially linearly change according to the NiO content. Thus, for convenience, the linear expansion coefficients α in the above formulas for calculating moments each may be replaced with the NiO content (Cn1 or Cn2) of each layer. In this case, the coefficient of thermal expansion αe of the solid electrolyte 2 is 0 (zero). The absolute value of the warpage change index i calculated in this manner is preferably 0.5 or less.

By the above method, the effect of suppressing warpage due to factor (i) can be predicted. The effect of suppressing warpage due to factor (ii) can be represented as a warpage change index ii by using the amount of change in outer diameter of anode layers as a result of reduction treatment in place of determining the difference between a linear expansion coefficient of a base layer and linear expansion coefficients of other layers. The absolute value of the sum of the warpage change index i and the warpage change index ii is preferably 0.5 or less.

### [Composite Member]

One embodiment of the composite member will now be described with reference to FIGS. 1A to 1C. FIGS. 1A to 1C are schematic sectional views of electrolyte layer-anode composite members according to different embodiments.

A composite member 10 includes the first anode layer 1a, the second anode layer 1b, and the solid electrolyte layer 2. The second anode layer 1b is interposed between the solid electrolyte layer 2 and the first anode layer 1a. The first anode layer 1a, the second anode layer 1b, and the solid electrolyte layer 2 are integrated by firing.

### [Solid Electrolyte Layer]

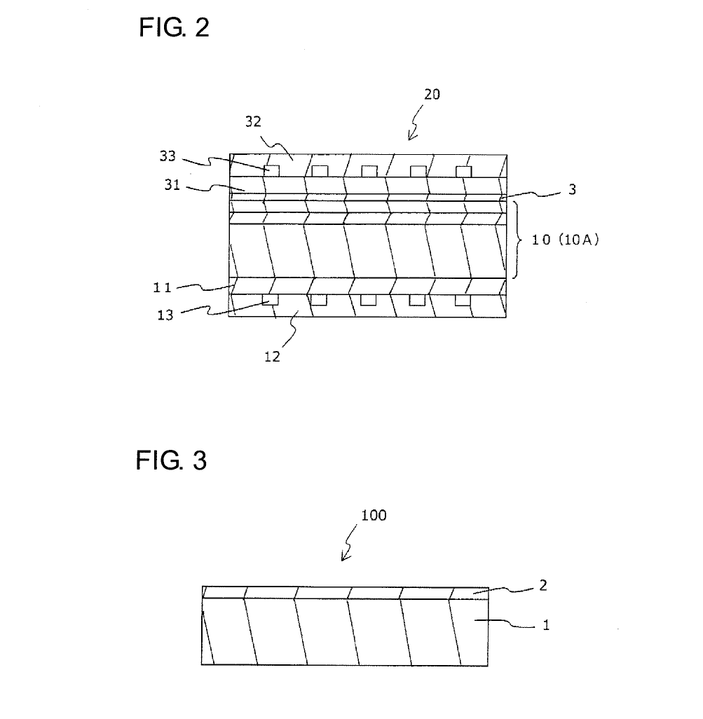

The solid electrolyte layer 2 contains an ionically conductive metal oxide M1. When the metal oxide M1 has proton conductivity, the solid electrolyte layer 2 transfers protons produced in the anode 1 to a cathode 3 (see FIG. 2). When the metal oxide M1 has oxygen ion conductivity, the solid electrolyte layer 2 transfers oxygen ions produced in the cathode 3 to the anode 1.

To achieve both ion conductivity and gas blocking performance, the thickness Te of the solid electrolyte layer 2 is preferably 3 to 50 μm, more preferably 5 to 30 μm. In this case, (T1+T2)/Te, which is a ratio of the total thickness of the thickness T1 of the first anode layer 1a and the thickness T2 of the second anode layer 1b to the thickness Te, the anode layers being described below, is preferably 10 or more, more preferably 30 or more. When the anode 1 is sufficiently thick relative to the solid electrolyte layer 2, the anode 1 readily supports the solid electrolyte layer 2.

The solid electrolyte layer 2 may be a laminate of multiple solid electrolyte layers. In this case, the metal oxides M1 contained in the solid electrolyte layers may be of the same type or of different types. “Metal oxides of the same type” refers to those containing the same metal elements, and their atomic compositional ratio may be different (hereinafter the same). For example, metal oxides containing barium (Ba), zirconium (Zr), and yttrium (Y) and having different atomic compositional ratios of Zr and Y are of the same type.

### [Metal Oxide M1]

The metal oxide M1 may be, for example, a known material used as a fuel cell solid electrolyte. In particular, preferred examples of the metal oxide M1 having proton conductivity include compounds having a perovskite crystal structure represented by A¹B¹O₃ (hereinafter, perovskite oxides P1). A¹B¹O₃ includes a crystal structure of A¹B¹O_{3-δ} (δ is an oxygen deficiency). The perovskite crystal structure is a crystal structure similar to CaTiO₃. A¹ site contains an element having an ion radius larger than that of an element in B¹ site. Preferred examples of the metal oxide M1 having oxygen ion conductivity include a compound Z1 containing zirconium dioxide.

The metal element in A¹ site may be, for example, but not necessarily, a group 2 element such as Ba, calcium (Ca), or strontium (Sr). These may be used alone or in combination. In particular, A¹ site preferably contains Ba from the viewpoint of proton conductivity.

Examples of the metal element in B¹ site include cerium (Ce), Zr, and Y. In particular, B¹ site preferably contains at least one of Zr and Ce from the viewpoint of proton conductivity. B¹ site is partially substituted with a trivalent rare-earth element other than cerium, and such a dopant causes oxygen vacancy, so that the perovskite oxide P1 exhibits proton conductivity.

Examples of the trivalent rare-earth element (dopant) other than cerium include yttrium (Y), scandium (Sc), neodymium (Nd), samarium (Sm), gadolinium (Gd), holmium (Ho), erbium (Er), thulium (Tm), ytterbium (Yb), and lutetium (Lu). In particular, Y or an element having an ion radius smaller than that of Y preferably occupies part of B¹ site from the viewpoint of proton conductivity and chemical stability. Examples of the element having an ion radius smaller than that of Y include Sc, Ho, Er, Tm, Yb, and Lu. B¹ site may also contain an element (e.g., indium (In)) other than rare-earth elements that acts as a dopant.

Among the perovskite oxides P1, preferred are compounds represented by formula (1-1): BaCe₁₋ₐ₁Yₐ₁O_{3-δ} (0<a1≤0.5, BCY), formula (2-1): BaZr_{1-b1}Y_{b1}O_{3-δ} (0<b1≤0.5, BZY), and formula (3-1): BaZr_{1-c1-d1}Ce_{c1}Y_{d1}O_{3-δ} (0<c1<1, 0<d1≤0.5, BZCY), which is a solid solution of (1-1) and (2-1), because these compounds have particularly high proton conductivity and exhibit high power generation performance. These perovskite oxides P1 may be used alone or in combination. In this case, Yin B¹ site may be partially substituted with other elements (e.g., other lanthanoids), and Ba in A¹ site may be partially substituted with other group 2 elements (e.g., Sr and Ca).

The compound Z1, another preferred example of the metal oxide M1, preferably contains, together with zirconium dioxide, at least one element that substitutes Zr to form a solid solution selected from the group consisting of Ca, Sc and Y. This causes the compound Z1 to exhibit oxygen ion conductivity.

The compound Z1 is preferably, for example, yttria-stabilized zirconia (ZrO₂—Y₂O₃, YSZ) in terms of oxygen ion conductivity and cost.

The solid electrolyte layer 2 may contain a component other than the metal oxide M1, preferably in a small amount. For example, the metal oxide M1 preferably constitutes 99% by mass or more of the solid electrolyte layer 2. Examples of the component other than the metal oxide M1 include, but are not limited to, compounds (including non-ion-conductive compounds) known as solid electrolytes.

### [Anode]

The anode 1 at least includes the first anode layer 1a and the second anode layer 1b. The first anode layer 1a and the second anode layer 1b each contain an ionically conductive metal oxide (M2 or M3) and NiO. The NiO content Cn1 of the first anode layer 1a and the NiO content Cn2 of the second anode layer 1b satisfy Cn1<Cn2. The NiO content Cn can be determined as described above.

The anode 1 is made porous by reduction treatment. In the anode 1 that has been made porous, a reaction (fuel oxidation) occurs in which a fuel such as hydrogen introduced through a channel described below is oxidized to release protons and electrons, or a reaction occurs in which a fuel is oxidized to produce H₂O (CO₂, in the case where the fuel is a hydrocarbon such as CH₄).

The thickness T1 of the first anode layer 1a and the thickness T2 of the second anode layer 1b are not limited to any particular values. The total thickness of the anode 1 including the first anode layer 1a and the second anode layer 1b is preferably 0.3 to 5 mm, more preferably 0.5 to 4 mm.

The ratio of the thickness T1 to the thickness T2 (T1/T2) is also not limited to any particular value, and may be appropriately determined taking into account the balance between suppression of warpage and power generation performance and the NiO contents of the layers. Possible cases include, for example, case 1 (e.g., the thickness T2 is at least one order of magnitude (at least 10 times) smaller than the thickness T1, see FIG. 1A), case 2 (e.g., the thickness T2 is more than 1/10 and less than 10 times the thickness T1, see FIG. 1B), and case 3 (e.g., the thickness T2 is at least one order of magnitude (at least 10 times) larger than the thickness T1, see FIG. 1C).

The anode 1 may include three or more anode layers. In other words, the first anode layer 1a and the second anode layer 1b may each be formed of multiple anode layers, or the anode 1 may include a third anode layer (not shown) other than the first anode layer 1a and the second anode layer 1b. The third anode layer may be deposited on a surface of the first anode layer 1a that does not face the second anode layer 1b. Furthermore, as long as the effect of this embodiment is not adversely affected, the third anode layer may be deposited between the first anode layer 1a and the second anode layer 1b or between the second anode layer 1b and the solid electrolyte layer 2. The third anode layer may contain an ionically conductive metal oxide and NiO.

When a gas containing ammonia, methane (CH₄), or propane, which produces hydrogen when decomposed, is introduced into the anode 1, the gas undergoes decomposition to produce hydrogen in the anode 1. That is, the composite member has gas decomposability, and the composite member can be used for a gas decomposition device. When a solid may be formed after gas decomposition as in the case of carbon-containing gases (e.g., CH₄), it is preferable to use metal oxides having oxygen ion conductivity for the layers constituting the composite member.

For example, when ammonia is decomposed by using a proton conductive metal oxide, hydrogen produced through the decomposition of ammonia is oxidized in the anode 1 to produce protons. The protons transfer to the cathode through the solid electrolyte layer 2. N₂ which has been produced simultaneously through the decomposition of ammonia is discharged as exhaust gas through a fuel gas outlet described below. The anode 1 may contain a catalyst capable of decomposing the above-described gases. Examples of the catalyst capable of decomposing gases such as ammonia include compounds containing at least one catalytic element selected from the group consisting of Fe, Co, Ti, Mo, W, Mn, Ru, and Cu.

### [Metal Oxide M2]

The metal oxide M2 contained in the first anode layer 1a has ion conductivity. Examples of the metal oxide M2 include the same metal oxides as those exemplified as the metal oxide M1. Specifically, preferred examples of the metal oxide M2 include compounds having a perovskite crystal structure represented by A²B²O₃ (hereinafter, perovskite oxides P2) and a compound Z2 containing zirconium dioxide. A²B²O₃ includes a crystal structure of A²B²O_{3-δ} (δ is an oxygen deficiency). A² site contains an element having an ion radius larger than that of an element in B² site.

Among the perovskite oxides P2, preferred are compounds represented by formula (1-2): BaCe₁₋ₐ₂Yₐ₂O_{3-δ} (0<a2≤0.5, BCY), formula (2-2): BaZr_{1-b2}Y_{b2}O_{3-δ} (0<b2≤0.5, BZY), and formula (3-2): BaZr_{1-c2-d2}Ce_{c2}Y_{d2}O_{3-δ} (0<c2<1, 0<d2≤0.5, BZCY), which is a solid solution of (1-2) and (2-2), because these compounds have particularly high proton conductivity and exhibit high power generation performance. These perovskite oxides P2 may be used alone or in combination. In this case, Y in B² site may be partially substituted with other elements (e.g., other lanthanoids), and Ba in A² site may be partially substituted with other group 2 elements (e.g., Sr and Ca).

Examples of the compound Z2 containing zirconium dioxide include the same metal oxides as those exemplified as the compound Z1. In particular, YSZ is preferred in terms of oxygen ion conductivity and cost.

### [Metal Oxide M3]

The metal oxide M3 contained in the second anode layer 1b also has ion conductivity. Examples of the metal oxide M3 include the same compounds as those exemplified as the metal oxides M1 and M2.

Specifically, preferred examples of the metal oxide M3 include compounds having a perovskite crystal structure represented by A³B³O₃ (hereinafter, perovskite oxides P3) and a compound Z3 containing zirconium dioxide. A³B³O₃ includes a crystal structure of A³B³O_{3-δ} (δ is an oxygen deficiency). A³ site contains an element having an ion radius larger than that of an element in B³ site.

Examples of the elements in A³ site and B³ site of the perovskite oxides P3 include the same elements as the elements in A¹ (A²) site and B¹ (B²) site. Among the perovskite oxides P3, preferred are compounds represented by formula (1-3): BaCe₁₋ₐ₃Yₐ₃O_{3-δ} (0<a3≤0.5, BCY), formula (2-3): BaZr_{1-b3}Y_{b3}O_{3-δ} (0<b3≤0.5, BZY), and formula (3-3): BaZr_{1-c3-d3}Ce_{c3}Y_{d3}O_{3-δ} (0<c3<1, 0<d3≤0.5, BZCY), which is a solid solution of (1-3) and (2-3), because these compounds have particularly high proton conductivity and exhibit high power generation performance. These perovskite oxides P3 may be used alone or in combination. In this case, Y in B³ site may be partially substituted with other elements (e.g., other lanthanoids), and Ba in A³ site may be partially substituted with other group 2 elements (e.g., Sr and Ca).

Examples of the compound Z3 containing zirconium dioxide include the same metal oxides as those exemplified as the compound Z1 (Z2). In particular, YSZ is preferred in terms of oxygen ion conductivity and cost.

The metal oxides M2 and M3 may be of the same type or of different types. In particular, from the viewpoint of the integrity of a boundary between the anode layers, suppression of warpage, and suppression of interdiffusion of metal elements, the metal oxides M2 and M3 are preferably of the same type.

Furthermore, to easily make uniform the behavior in firing the layers and to easily maintain the integrity of boundaries of the layers, the metal oxides M1, M2, and M3 preferably contains metal oxides of the same type. This enables control and suppression of deformation, breakage, etc. that might otherwise be caused by differences in contraction behavior during co-sintering of the layers and in the amount of contraction during cooling after co-sintering and during reduction treatment.

### [Method for Producing Composite Member]

The electrolyte layer-anode composite member is produced, for example, by a method including a first step of preparing a solid electrolyte layer material containing an ionically conductive metal oxide M1, an anode material A containing an ionically conductive metal oxide M2 and a nickel compound N1, and an anode material B containing an ionically conductive metal oxide M3 and a nickel compound N2; a second step of forming a laminate of a precursor layer of a first anode layer containing the anode material A, a precursor layer of a second anode layer containing the anode material B, and a precursor layer of a solid electrolyte layer containing the solid electrolyte layer material, the precursor layers being deposited on one another in this order; and a third step of firing the laminate to form the first anode layer, the second anode layer, and the solid electrolyte layer. In the third step, the nickel compound N1 and the nickel compound N2 (excluding NiO) are oxidized to form NiO. A volume content Cn1 of NiO in the first anode layer and a volume content Cn2 of NiO in the second anode layer satisfy the relation Cn1<Cn2. These steps will now be described in detail.

### (First Step)

In the first step, the solid electrolyte material, the anode material A, and the anode material B are prepared. The solid electrolyte material is a material for forming the solid electrolyte layer 2 and contains the ionically conductive metal oxide M1. The anode material A is a material for forming the first anode layer 1a and contains the ionically conductive metal oxide M2 and the nickel compound N1. The anode material B is a material for forming the second anode layer 1b and contains the ionically conductive metal oxide M3 and the nickel compound N2.

Examples of the nickel compounds N1 and N2 include hydroxides, salts (e.g., inorganic acid salts such as carbonates), and halides. In particular, nickel oxides such as NiO are suitable for use because they undergo little volume change until the third step and their contraction behavior is easy to control.

The nickel compounds may be used alone or in combination.
The nickel compounds N1 and N2 may be the same or different.

A content Cna of the nickel compound N1 in the anode material A may be any amount that allows the NiO content Cn1 of the first anode layer 1a after firing to be, for example, 40% to 80% by volume. Likewise, a content Cnb of the nickel compound N2 in the anode material B may be any amount that allows the NiO content Cn2 of the second anode layer 1b after firing to be, for example, 50% to 90% by volume.

From the viewpoint of formability, each material preferably contains a binder. Examples of the binder include known materials used to produce ceramic materials, for example, cellulose derivatives (e.g., cellulose ethers) such as ethylcellulose, vinyl acetate resins (including saponified vinyl acetate resins such as provinyl alcohols), and polymer binders such as acrylic resins; and waxes such as paraffin wax.

The amount of binder contained in each anode material is, for example, 1 to 15 parts by mass (particularly, 3 to 10 parts by mass) when the anode material is subjected to press forming, and, for example, 1 to 20 parts by mass (particularly, 1.5 to 15 parts by mass) in other cases, based on 100 parts by mass total metal oxide and nickel compound. The amount of binder in the solid electrolyte material is, for example, 1 to 20 parts by mass (particularly, 1.5 to 15 parts by mass) based on 100 parts by mass metal oxide.

Each material may optionally contain dispersion media such as water and organic solvents (e.g., hydrocarbons such as toluene; alcohols such as ethanol and isopropanol; and Carbitols such as butyl Carbitol acetate). Each material may optionally contain various additives such as surfactants and deflocculants (e.g., polycarboxylic acids).

### (Second Step)

In the second step, a laminate of a precursor layer of the first anode layer 1a containing the anode material A, a precursor layer of the second anode layer 1b containing the anode material B, and a precursor layer of the solid electrolyte layer 2 containing the solid electrolyte layer material, the precursor layers being deposited on one another in this order, is formed.

The precursor layers may be formed by any method. An appropriate method may be selected according to the desired thickness of each layer. For example, a precursor layer having a thickness of several hundred micrometers or more can be formed, for example, by a method such as press-forming or tape-casting. A precursor layer having a thickness of several to several hundred micrometers can be formed by a known method such as screen printing, spray coating, spin coating, or dip coating. These methods may be combined to form a laminate. The precursor layer of the solid electrolyte layer 2 is typically formed by screen printing, spray coating, spin coating, dip coating, etc.

In case 1 (specifically, the thickness T1 is 0.3 to 5 mm, and the thickness T2 is 5 to 50 μm), as shown in FIG. 1A, the anode material A is first formed into a predetermined shape by press-forming. The predetermined shape is, for example, a pellet shape, a plate shape, or a sheet shape. Prior to the forming, the anode material A may be granulated to form a granulated product. The granulated product may optionally be disintegrated before being formed.

The precursor layer of the second anode layer 1b is then deposited on a surface of the formed precursor layer of the first anode layer 1a. The precursor layer of the second anode layer 1b is formed by applying the anode material B to the surface of the precursor layer of the first anode layer 1a, for example, by screen printing, spray coating, spin coating, or dip coating. The solid electrolyte material is then applied to a surface of the formed precursor layer of the second anode layer 1b by the same method to form the precursor layer of the solid electrolyte layer. In this manner, the laminate is obtained.

In case 2 (see FIG. 1B), the precursor layer of the first anode layer 1a and the precursor layer of the second anode layer 1b may be formed in a single step by placing powders of the anode materials in layers in a press-forming machine and then performing press-forming. In case 3 (see FIG. 1C), the anode material B is formed into a predetermined shape, for example, by press-forming, and the solid electrolyte material and the anode material A are then applied to different surfaces of the formed precursor layer of the second anode layer 1b by the method described above. Alternatively, the solid electrolyte material may be applied to a surface of the precursor layer of the second anode layer 1b after the precursor layer of the first anode layer 1a and the precursor layer of the second anode layer 1b are formed by tape-casting and deposited on each other.

Before the application of the solid electrolyte material, a step of calcining the precursor layer of the second anode layer 1b may be performed. The calcination may be performed at a temperature (e.g., 900° C. to 1,100° C.) lower than a temperature at which the anode material B is sintered. The calcination facilitates the application of the solid electrolyte material.

### (Third Step)

In the third step, the laminate obtained is fired. The firing is performed by heating the laminate, for example, to 1,200° C. to 1,700° C. in an oxygen-containing atmosphere. The oxygen content of the firing atmosphere is not limited to any particular value. The firing may be performed, for example, in an air atmosphere (oxygen content: about 20% by volume) or in pure oxygen (oxygen content: 100% by volume). The firing may be performed without pressure or under pressure.

Before the laminate is fired, resin components such as binders contained in the materials may be removed. Specifically, the firing may be performed after the resin components contained in the materials have been removed by heating the laminate in the air to a relatively low temperature of about 500° C. to 700° C.

As a result of the firing of the laminate, the anode material A, the anode material B, and the solid electrolyte material are co-sintered. This provides the composite member 10 in which the first anode layer 1a, the second anode layer 1b, and the solid electrolyte layer 3 are integrally formed.

### (Fourth Step)

Furthermore, a reduction treatment (fourth step) may be performed to at least partially reduce NiO contained in the formed first anode layer 1a and NiO contained in the second anode layer 1b. The reduction treatment is performed by heating the composite member 10 typically to 500° C. to 800° C. in a reducing gas atmosphere. The reduction treatment may be performed without pressure or under pressure. A typical reducing gas is hydrogen. When the composite member 10 contains a metal oxide having oxygen ion conductivity, for example, a hydrocarbon such as methane or propane as well as hydrogen may be used as a reducing gas. The reduction treatment may be performed before or after the composite member 10 is incorporated into a fuel cell 20.

### [Fuel Cell]

FIG. 2 schematically illustrates a section of a structure of the fuel cell 20.

The fuel cell 20 includes a cell including the composite member 10 (10A) and the cathode 3, an oxidant channel 33 for supplying an oxidant to the cathode 3, and a fuel channel 13 for supplying a fuel to the anode. As a non-limiting example, a composite member 10A shown in FIG. 1A is used as a composite member in the illustrated example.

Since the composite member 10 has the configuration described above, warpage of the composite member 10 is suppressed when the temperature is increased and decreased during the operation of the fuel cell 20. This suppresses degradation of the cell that might otherwise be caused as a result of thermal fatigue, leading to improved durability of the fuel cell 20. The composite member 10 may be, but not necessarily, subjected to reduction treatment.

The oxidant channel 33 has an oxidant inlet through which an oxidant flows in and an oxidant outlet through which reaction product water, unused oxidant, etc. are discharged (neither shown). An example of the oxidant is a gas containing oxygen. The fuel channel 13 has a fuel gas inlet through which fuel gas flows in and a fuel gas outlet through which unused fuel and reaction product H₂O (CO₂, in the case where the fuel is a hydrocarbon such as CH₄) are discharged (neither shown).

When the metal oxide M1 contained in the solid electrolyte layer 2 has oxygen ion conductivity, the fuel cell 20 is operable in a temperature range of 800° C. or lower, and when the metal oxide M1 has proton conductivity, the fuel cell 20 is operable in a temperature range of 700° C. or lower. The operating temperature is preferably an intermediate temperature in the range of about 400° C. to 600° C.

The cathode 3 is capable of adsorbing oxygen molecules and dissociating the oxygen molecules into ions and has a porous structure. For example, when the metal oxide M1 has proton conductivity, a reaction between protons conducted through the solid electrolyte layer 2 and oxide ions (reduction reaction of oxygen) occurs in the cathode 3. The oxide ions are produced through dissociation of an oxidant (oxygen) introduced through an oxide channel described below.

The cathode may be made of any known material used, for example, for cathodes of fuel cells and gas decomposition devices. In particular, perovskite oxides are preferred. Specific examples include lanthanum strontium cobalt ferrite (LSCF, La₁₋ₑSrₑCo_{1-f}Fe_{f}O_{3-δ}, 0<e<1, 0<f<1, δ is an oxygen deficiency), lanthanum strontium manganite (LSM, La_{1-g}Sr_{g}MnO_{3-δ}, 0<g<1, δ is an oxygen deficiency), lanthanum strontium cobaltite (LSC, La₁₋ₕSrₕCoO_{3-δ}, 0<h<1, δ is an oxygen deficiency), and samarium strontium cobaltite (SSC, Sm₁₋ᵢSrᵢCoO_{3-δ}, 0<i<1, δ is an oxygen deficiency).

The cathode 3 may contain a catalyst such as Ag. This is because the reaction between protons and an oxidant is promoted. When containing a catalyst, the cathode 3 can be formed by mixing the catalyst with any of the above-described materials and sintering the mixture. The thickness of the cathode 3 may be, but not necessarily, about 10 μm to 30 μm.

The oxidant channel 33 may be formed, for example, in a cathode separator 32 disposed outwardly of the cathode. Likewise, the fuel channel 13 may be formed, for example, in an anode separator 12 disposed outwardly of the anode.

When a fuel cell 10 is composed of layered cell structures, for example, units of a cell, the cathode separator 32, and the anode separator 12 are deposited on one another. The cells may be connected in series, for example, through a separator having gas channels (an oxidant channel and a fuel channel) on both sides.

Examples of materials for the separators include heat-resistant alloys such as stainless steel, nickel-base alloys, and chromium-base alloys, in terms of conductivity and heat resistance. Of these, stainless steel is preferred for its low cost. When the operating temperature of the fuel cell 20 is about 400° C. to 600° C., stainless steel can be used as a material for the separators.

The fuel cell 20 may further include a current collector. For example, the fuel cell 20 may include a cathode current collector 31 disposed between the cathode and the cathode separator 32 and an anode current collector 11 disposed between the anode and the anode separator 12. The cathode current collector 31 functions not only to collect a current but also to supply oxidant gas introduced through the oxidant channel 33 to the cathode 3 while diffusing the oxidant gas. The anode current collector 11 functions not only to collect a current but also to supply fuel gas introduced through the fuel channel 13 to the anode 1 while diffusing the fuel gas. Therefore, the current collectors are preferably air-permeable structures.

Examples of structures that may be used as the current collectors include porous metal bodies, meshed metals, perforated metals, and expanded metals containing platinum, silver, silver alloys, Ni, Ni alloys, etc. Of these, porous metal bodies are preferred for their light weight and air-permeability. In particular, porous metal bodies having three-dimensional mesh-like structures are preferred. “Three-dimensional mesh-like structure” refers to a structure in which rods or fibers of metal that form a porous metal body are three-dimensionally linked together to form a network. Examples include sponge-like structures and nonwoven-fabric-like structures.

Such a porous metal body can be formed, for example, by coating a porous resin body having continuous pores with a metal as described above. After the metal coating process, the resin inside is removed to leave cavities inside the frame of the porous metal body, thus forming a hollow structure. An example of a commercially available porous metal body having such a structure is “Celmet” (registered trademark) available from Sumitomo Electric Industries, Ltd.

The present invention will now be described in more detail with reference to examples, but the following examples are not intended to limit the present invention.

### Example 1

A composite member was produced by the following procedure.

### (1) Preparation of Materials

A BCY powder, BCY being a solid solution of BaCeO₃ and Y₂O₃ and having a perovskite crystal structure, was prepared as a metal oxide. It was presumed that Ce and Y in the BCY were in a ratio (atomic compositional ratio) of 80:20 and hence the chemical formula of the BCY powder was BaCe_{0.8}Y_{0.2}O_{2.9}.

A powder mixture A containing a binder (acrylic resin, 20% by volume) and a mixture (80% by volume) obtained by mixing the BCY powder with 60% by volume NiO (catalyst material) (volume of NiO/volume of (BCY+NiO)=60%) and disintegrating and blending the mixture by using a ball mill was prepared as an anode material A.

A paste B containing a binder (cellulose resin, 30% by volume) and a mixture (70% by volume) obtained by mixing the BCY powder with 70% by volume NiO (catalyst material) and disintegrating and blending the mixture by using a ball mill was prepared as an anode material B.

A paste C containing the BCY powder (35% by volume), an organic solvent (butyl Carbitol acetate, 40% by volume), and a binder (cellulose resin, 25% by volume) was prepared as a solid electrolyte material.

### (2) Formation of Precursor Layer of First Anode Layer

Using the powder mixture A, a circular sheet-shaped product having a diameter of 140 mm and a thickness of 0.8 mm was formed by uniaxial press-forming.

### (3) Formation of Precursor Layer of Second Anode Layer

The paste B was applied to one surface of the shaped product by screen printing. The coating thickness was about 15 μm.

### (4) Formation of Precursor Layer of Solid Electrolyte Layer and Sintering

The paste C was applied to the surface of the paste B by screen printing to obtain a laminate. The coating thickness was about 15 μm.

The laminate was then heated in the air at 600° C. for 1 hour to remove the binder and the organic solvent. Subsequently, firing was performed in an oxygen atmosphere at 1,350° C. for 2 hours to obtain a composite member A. The composition of the composite member A is shown in Table 1. The composite member A showed no breakage such as cracking. The volume of the composite member A decreased by about 21% compared to the volume of the laminate.

### (5) Reduction Treatment

The composite member A was then heated in a hydrogen atmosphere at 600° C. for 10 hours to reduce NiO to Ni. After the reduction treatment, the Ni content of the second anode layer was about 37% by volume, and the Ni content of the first anode layer was about 32% by volume.

### (6) Warpage Evaluation

The amount of warpage after sintering and after reduction treatment and the amount of change in outer diameter after reduction treatment were measured. The amount of warpage was determined in such a manner that the composite member A was placed on a horizontal plane with a convex surface of the composite member upward and the shortest distance between the horizontal plane and the highest point of the convex surface was determined. The change in outer diameter was determined in such a manner that in the above-described state, a diameter of the composite member A as viewed from the normal direction of the horizontal plane was determined and compared with the diameter of the composite member (laminate) before sintering. The results are shown in Table 2.

### (7) Production of Fuel Cell

To evaluate power generation performance, a composite member having the same composition as that of the composite member A except that the composite member had an outer diameter of 25 mm was produced, and the composite member before reduction treatment was used to produce a cell. The cell was produced by applying an LSCF paste, a mixture of an LSCF (La_{0.6}Sr_{0.4}Co_{0.2}Fe_{0.8}O_{3-δ}) powder, serving as a cathode material, and the above-described organic solvent to the surface of the solid electrolyte layer of the composite member by screen printing, followed by firing at 1,000° C. for 2 hours. The thickness of the cathode was 10 μm.

Porous nickel current collectors (Celmet available from Sumitomo Electric Industries, Ltd., having a thickness of 1 mm and a porosity of 95% by volume) were deposited on the surfaces of the cathode and the anode of the cell obtained above. Next, a stainless steel cathode separator having an oxidant channel was deposited on the cathode current collector, and a stainless steel anode separator having a fuel channel was deposited on the anode current collector, thus producing a fuel cell A shown in FIG. 2. Each current collector was bonded to one end of a lead wire. The other end of each lead wire was routed outside the fuel cell and connected to a measuring instrument in order to measure the current and voltage between the lead wires.

### (8) Power Generation Performance Evaluation

At an operating temperature of 600° C., hydrogen as a fuel gas was passed through the anode of the fuel cell A at 100 cm³/min, and air was passed through the cathode at 300 cm³/min. A maximum power density during this process was determined. The reduction treatment was performed during this process. The results are shown in Table 2.

### Example 2

A composite member B and a fuel cell B were produced in the same manner as in Example 1 and evaluated, except that the NiO content of the first anode layer was 50% by volume. The results are shown in Table 2. The Ni content of the first anode layer after reduction treatment was about 27% by volume.

### Example 3

A composite member C and a fuel cell C were produced in the same manner as in Example 2 and evaluated, except that the thickness of the second anode layer was 30 μm. The results are shown in Table 2.

### Comparative Example 1

A composite member a and a fuel cell a were produced in the same manner as in Example 1 and evaluated, except that the NiO content of the first anode layer was 70% by volume and that the second anode layer was not formed. The results are shown in Table 2.

### Comparative Example 2

A composite member b and a fuel cell b were produced in the same manner as in Example 1 and evaluated, except that the second anode layer was not formed. The results are shown in Table 2.

### Comparative Example 3

A composite member c and a fuel cell c were produced in the same manner as in Example 2 and evaluated, except that the second anode layer was not formed. The results are shown in Table 2.

### Comparative Example 4

A composite member d and a fuel cell d were produced in the same manner as in Example 1 and evaluated, except that the NiO content of the first anode layer was 70% by volume and the NiO content of the second anode layer was 50% by volume. The results are shown in Table 2.

TABLE 1

| | Solid | Second anode | | First anode | |
|---|---|---|---|---|---|
| | electrolyte layer | layer | | layer | |
| Composite | Te | Cn2 | T2 | Cn1 | T1 |
| member | (μm) | (vol %) | (μm) | (vol %) | (mm) |
| A | 15 | 70 | 15 | 60 | 0.8 |
| B | 15 | 70 | 15 | 50 | 0.8 |
| C | 15 | 70 | 30 | 50 | 0.8 |
| a | 15 | — | — | 70 | 0.8 |
| b | 15 | — | — | 60 | 0.8 |
| c | 15 | — | — | 50 | 0.8 |
| d | 15 | 50 | 15 | 70 | 0.8 |

TABLE 2

| | After | After reduction treatment | | Power |
|---|---|---|---|---|
| | co-sintering | | Amount of | generation performance |
| Composite | Amount of | Amount of | contraction of outer | Maximum density |
| member | warpage (mm) | warpage (mm) | diameter (mm) | (mW/cm²) |
| A | 0.6 | 1.2 | −0.3 | 490 |
| B | 0.4 | 0.7 | −0.1 | 420 |
| C | 0.2 | 0.5 | 0 | 430 |
| a | 0.9 | 6.3 | −1.3 | 510 |
| b | 0.7 | 1.7 | −0.2 | 470 |
| c | 0.6 | 0.9 | 0 | 360 |
| d | 1.2 | 7.2 | −1.4 | 390 |

The composite members A to C underwent very little warpage and had excellent power generation performance. In the composite members B, C, and a to d, there was no breakage such as cracking, and the contraction rate of the entire composite member after sintering (before reduction treatment) was about 20% to 22%.

### Example 4

A composite member D and a fuel cell D were produced in the same manner as in Example 1 and evaluated, except that the type of metal oxide, the NiO content and the thickness of the anode layers, and the firing temperature were changed. The composition of the composite member D is shown in Table 3, and the results are shown in Table 4.

A BZY powder, BZY being a solid solution of BaZrO₃ and Y₂O₃ and having a perovskite crystal structure, was prepared as a metal oxide. It was presumed that Zr and Y in the BZY were in a ratio (atomic compositional ratio) of 80:20 and hence the chemical formula of the BZY powder was BaZr_{0.8}Y_{0.2}O_{2.9}. The firing temperature of the laminate was 1,500° C. There was no breakage such as cracking in the composite member D, and the contraction rate of the entire composite member D after sintering (before reduction treatment) was about 21%.

### Example 5

A composite member E and a fuel cell E were produced in the same manner as in Example 4 and evaluated, except that the NiO content of the second anode layer was 60% by volume. The results are shown in Table 4.

### Comparative Example 5

A composite member e and a fuel cell e were produced in the same manner as in Example 4 and evaluated, except that the NiO content of the second anode layer was 70% by volume and the first anode layer was not formed. The results are shown in Table 4.

### Comparative Example 6

A composite member f and a fuel cell f were produced in the same manner as in Example 5 and evaluated, except that the first anode layer was not formed. The results are shown in Table 4.

TABLE 3

| | Solid | Second anode | | First anode | |
|---|---|---|---|---|---|
| | electrolyte layer | layer | | layer | |
| Composite | Te | Cn2 | T2 | Cn1 | T1 |
| member | (μm) | (vol %) | (mm) | (vol %) | (μm) |
| D | 15 | 70 | 0.8 | 50 | 30 |
| E | 15 | 60 | 0.8 | 50 | 30 |
| e | 15 | 70 | 0.8 | — | — |
| f | 15 | 60 | 0.8 | — | — |

TABLE 4

| | After | After reduction treatment | | Power |
|---|---|---|---|---|
| | co-sintering | | Amount of | generation performance |
| Composite | Amount of | Amount of | contraction of outer | Maximum density |
| member | warpage (mm) | warpage (mm) | diameter (mm) | (mW/cm²) |
| D | 0.8 | 1.7 | −1.3 | 250 |
| E | 0.6 | 1.5 | −0.2 | 230 |
| e | 1.2 | 6.5 | −1.4 | 260 |
| f | 0.9 | 1.9 | −0.3 | 230 |

The composite members D and E exhibited power generation performance comparable to those of the composite members e and f. The amount of warpage of each of the composite members D and E was small. In the composite members E, e, and f, there was no breakage such as cracking, and the contraction rate of the entire composite member after sintering (before reduction treatment) was about 20% to 22%.

### Example 6

A composite member was produced by the following procedure.

### (1) Preparation of Materials

A YSZ powder, YSZ being a solid solution of ZrO₂ and Y₂O₃, was prepared as a metal oxide. Zr and Y in the YSZ were in a ratio (atomic compositional ratio) of 90:10.

A slurry A containing a binder (PVB resin, 45% by volume) and a mixture (55% by volume) obtained by mixing the YSZ powder with 68% by volume NiO (catalyst material) (volume of NiO/volume of (YSZ+NiO)=68%) and disintegrating and blending the mixture by using a ball mill was prepared as an anode material A.

A slurry B containing 70% by volume NiO was prepared as an anode material B in the same manner as described above.

A slurry C containing the YSZ powder (55% by volume) and a binder (PVB resin, 45% by volume) was prepared as a solid electrolyte material.

### (2) Formation of Precursor Layers (Sheet-Shaped Products)

Using the slurry A, a sheet-shaped product A having a thickness of 0.5 mm was formed by a doctor blade method. Similarly, the slurry B was used to form a sheet-shaped product B having a thickness of 0.5 mm, and the slurry C was used to form a sheet-shaped product C having a thickness of 12 μm.

### (3) Deposition of Sheet-Shaped Products and Sintering

The sheet-shaped products A, B, and C were laminated in this order to obtain a layered sheet having a total thickness of about 1.0 mm. The layered sheet was punched into a circle having a diameter of 140 mm to obtain a laminate.

The laminate was then heated in the air at 600° C. for 1 hour to remove the binder and the organic solvent. Subsequently, firing was performed in an oxygen atmosphere at 1,300° C. for 2 hours to obtain a composite member F. The composition of the composite member F is shown in Table 5. The composite member F showed no breakage such as cracking. The volume of the composite member F decreased by about 23% compared to the volume of the laminate.

### (4) Property Evaluation

The reduction treatment and the warpage evaluation were conducted in the same manner as in Example 1. Separately, a fuel cell was produced in the same manner as in Example 1 and evaluated for power generation performance at an operating temperature of 800° C. The results are shown in Table 6.

### Comparative Example 7

A composite member g and a fuel cell g were produced in the same manner as in Example 6 and evaluated, except that the NiO content of the first anode layer was 70% by volume. The results are shown in Table 6.

TABLE 5

| | Solid | Second anode | | First anode | |
|---|---|---|---|---|---|
| | electrolyte layer | layer | | layer | |
| Composite | Te | Cn2 | T2 | Cn1 | T1 |
| member | (μm) | (vol %) | (mm) | (vol %) | (mm) |
| F | 12 | 70 | 0.5 | 68 | 0.5 |
| g | 12 | 70 | 0.5 | 70 | 0.5 |

TABLE 6

| | After | After reduction treatment | | Power |
|---|---|---|---|---|
| | co-sintering | | Amount of | generation performance |
| Composite | Amount of | Amount of | contraction of outer | Maximum density |
| member | warpage (mm) | warpage (mm) | diameter (mm) | (mW/cm²) |
| F | 0.3 | 0.9 | −0.1 | 310 |
| g | 0.5 | 1.8 | −0.2 | 300 |

The composite member F exhibited power generation performance comparable to that of the composite member g. The amount of warpage of the composite member F was small.

There was no breakage such as cracking in the composite member g.

### REFERENCE SIGNS LIST

1: anode, 1a: first anode layer, 1b: second anode layer, 2: solid electrolyte layer, 3: cathode, 10 and 10A to 10C: composite member, 20: fuel cell, 11 and 31: current collector, 12 and 32: separator, 13: fuel channel, 33: oxidant channel, 100: conventional composite member

1. An electrolyte layer-anode composite member for a fuel cell, comprising:
a solid electrolyte layer containing an ionically conductive metal oxide M1;
a first anode layer containing an ionically conductive metal oxide M2 and nickel oxide; and
a second anode layer interposed between the solid electrolyte layer and the first anode layer and containing an ionically conductive metal oxide M3 and nickel oxide,
wherein a volume content Cn1 of the nickel oxide in the first anode layer and a volume content Cn2 of the nickel oxide in the second anode layer satisfy a relation Cn1<Cn2.

2. The electrolyte layer-anode composite member for a fuel cell according to claim 1,
wherein the Cn1 is 40% to 80% by volume, and
the Cn2 is 50% to 90% by volume.

3. The electrolyte layer-anode composite member for a fuel cell according to claim 1,
wherein the solid electrolyte layer has a thickness Te of 3 to 50 μm, and
(T1+T2)/Te, which is a ratio of a total thickness of a thickness T1 of the first anode layer and a thickness T2 of the second anode layer to the thickness Te, is 10 or more.

4. The electrolyte layer-anode composite member for a fuel cell according to claim 1,
wherein the metal oxide M1 has a perovskite crystal structure represented by A¹B¹O₃, A¹ site contains at least one group 2 element, and
B¹ site contains at least one of cerium and zirconium and a rare-earth element.

5. The electrolyte layer-anode composite member for a fuel cell according to claim 4,
wherein the metal oxide M1 is at least one selected from the group consisting of compounds represented by
BaCe₁₋ₐ₁Yₐ₁O_{3-δ} formula (1-1):
(where 0<a1≤0.5, and δ is an oxygen deficiency),
BaZr_{1-b1}Y_{b1}O_{3-δ} formula (2-1):
(where 0<b1≤0.5, and δ is an oxygen deficiency), and
BaZr_{1-c1-d1}Ce_{c1}Y_{d1}O_{3-δ} formula (3-1):
(where 0<c1<1, 0<d1≤0.5, and δ is an oxygen deficiency).

6. The electrolyte layer-anode composite member for a fuel cell according to claim 1,
wherein the metal oxide M2 has a perovskite crystal structure represented by A²B²O₃, A² site contains at least one group 2 element, and
B² site contains at least one of cerium and zirconium and a rare-earth element.

7. The electrolyte layer-anode composite member for a fuel cell according to claim 6,
wherein the metal oxide M2 is at least one selected from the group consisting of compounds represented by
BaCe₁₋ₐ₂Yₐ₂O_{3-δ} formula (1-2):
(where 0<a2≤0.5, and δ is an oxygen deficiency),
BaZr_{1-b2}Y_{b2}O_{3-δ} formula (2-2):
(where 0<b2≤0.5, and δ is an oxygen deficiency), and
BaZr_{1-c2-d2}Ce_{c2}Y_{d2}O_{3-δ} formula (3-2):
(where 0<c2<1, 0<d2≤0.5, and δ is an oxygen deficiency).

8. The electrolyte layer-anode composite member for a fuel cell according to claim 1,
wherein the metal oxide M3 has a perovskite crystal structure represented by A³B³O₃, A³ site contains at least one group 2 element, and
B³ site contains at least one of cerium and zirconium and a rare-earth element.

9. The electrolyte layer-anode composite member for a fuel cell according to claim 8,
wherein the metal oxide M3 is at least one selected from the group consisting of compounds represented by
BaCe₁₋ₐ₃Yₐ₃O_{3-δ} formula (1-3):
(where 0<a3≤0.5, and δ is an oxygen deficiency),
BaZr_{1-b3}Y_{b3}O_{3-δ} formula (2-3):
(where 0<b3≤0.5, and δ is an oxygen deficiency), and
BaZr_{1-c3-d3}Ce_{c3}Y_{d3}O_{3-δ} formula (3-3):
(where 0<c3<1, 0<d3≤0.5, and δ is an oxygen deficiency).

10. The electrolyte layer-anode composite member for a fuel cell according to claim 1, wherein the metal oxide M1 contains zirconium dioxide doped with at least one selected from the group consisting of calcium, scandium, and yttrium.

11. The electrolyte layer-anode composite member for a fuel cell according to claim 1, wherein the metal oxide M2 contains zirconium dioxide doped with at least one selected from the group consisting of calcium, scandium, and yttrium.

12. The electrolyte layer-anode composite member for a fuel cell according to claim 1, wherein the metal oxide M3 contains zirconium dioxide doped with at least one selected from the group consisting of calcium, scandium, and yttrium.

13. The electrolyte layer-anode composite member for a fuel cell according to claim 1, wherein the nickel oxide contained in at least one of the first anode layer and the second anode layer is at least partially reduced to metal nickel.

14. A method for producing an electrolyte layer-anode composite member for a fuel cell, comprising:
a first step of preparing
a solid electrolyte layer material containing an ionically conductive metal oxide M1,
an anode material A containing an ionically conductive metal oxide M2 and a nickel compound N1, and
an anode material B containing an ionically conductive metal oxide M3 and a nickel compound N2;
a second step of forming a laminate of a precursor layer of a first anode layer containing the anode material A, a precursor layer of a second anode layer containing the anode material B, and a precursor layer of a solid electrolyte layer containing the solid electrolyte layer material, the precursor layers being deposited on one another in this order; and
a third step of firing the laminate to form the first anode layer, the second anode layer, and the solid electrolyte layer,
wherein a volume content Cn1 of the nickel oxide in the first anode layer and a volume content Cn2 of the nickel oxide in the second anode layer satisfy a relation Cn1<Cn2.

15. The method for producing an electrolyte layer-anode composite member for a fuel cell according to claim 14, further comprising a fourth step of at least partially reducing the nickel oxides contained in the first anode layer and the second anode layer.

16. A fuel cell comprising:
the electrolyte layer-anode composite member according to claim 1;
a cathode;
an oxidant channel for supplying an oxidant to the cathode; and
a fuel channel for supplying a fuel to the anode.
